(19) United States
(12) Patent Application Publication
(10) Pub. No.: US 2024/0342520 A1
(43) Pub. Date: Oct. 17, 2024

(54) HARNESS FOR FALL PROTECTION

(71) Applicant: Honeywell Safety Products USA, Inc., Charlotte, NC (US)

(72) Inventors: Peng ZHOU, Charlotte, NC (US); Ling LIN, Charlotte, NC (US); Xiaojuan Zhu, Charlotte, NC (US); Zheng GU, Charlotte, NC (US); Bojun SHAN, Charlotte, NC (US); Bin LIU, Charlotte, NC (US)

(21) Appl. No.: 18/616,978

(22) Filed: Mar. 26, 2024

(30) Foreign Application Priority Data
Apr. 13, 2023 (CN) 202310395486.2

(51) Int. Cl. A62B 35/00

(52) U.S. Cl. CPC A62B 35/0018; A62B 35/0037

(57) ABSTRACT

In various aspects, a harness includes a connector, a first strap coupled to the connector, a second strap coupled to the connector, and a web that is coupled to the first strap and the second strap. The web is positioned at least partially behind the connector.

### CROSS-REFERENCE TO RELATED APPLICATIONS

This application claims priority pursuant to 35 U.S.C. 119 (a) to Chinese Application No. 202310395486.2, filed Apr. 13, 2023, which application is incorporated herein by reference in its entirety.

### TECHNICAL FIELD

The present application relates generally to a harness. More specifically, the present application relates to a safety harness for fall protection.

### BACKGROUND

Safety harnesses are commonly used as part of a fall protection system for users who are at risk of a fall from a dangerous height. The use of a safety harnesses may prevent serious injury or fatality that result from a fall event. Fall protection harnesses generally include straps and buckles that secure the worker to a lanyard, cable, rope, or the like, that is attached to an anchor point.

The inventors of the present disclosure have identified numerous deficiencies and problems with the existing technologies in this field. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include systems and apparatuses to provide for improved safety harnesses for fall protection. For example, the harness of the present disclosure may allow for safety devices to be coupled to a connector that is on the back of the harness. The harness of the present disclosure may reduce the likelihood of injury and/or minimize the anxiety of a user wearing the harness after a fall event.

In various aspects, a harness includes a connector, a first strap coupled to the connector, a second strap coupled to the connector, and a web that is coupled to the first strap and the second strap. The web can be positioned at least partially behind the connector.

In various examples, the web is X-shaped.

In various examples, the first strap includes an upper portion and a lower portion and the second strap includes an upper portion and a lower portion. The web can be coupled to the upper portions and the lower portions of each of the first strap and the second strap.

In various examples, the web includes a first portion and a second portion. The first portion of the web can be coupled to the first strap. The second portion of the web can be coupled to the second strap.

In various examples, the first portion is positioned at an angle relative to the second portion. The angle can be at least 35 degrees and up 55 degrees.

In various examples, the first portion or the second portion crosses over the other of the first portion or the second portion.

In various examples, the connector includes a safety device interface configured to engage a first safety device so as to operatively couple the first safety device to the connector.

In various examples, the connector includes a base that includes a first base opening configured to receive the first strap and a second base opening configured to receive the second strap.

In various examples, the web is not directly coupled to the connector.

In various examples, the web is sewn to the first strap and the second strap.

In various examples, the first strap is coupled to the connector by extending through a first upper base opening of the connector, extending behind the connector, and extending through a first lower base opening of the connector, and wherein the second strap is coupled to the connector by extending through a second upper base opening of the connector, extending behind the connector, and extending through a second lower base opening of the connector.

In various examples, the web can be coupled to the first strap by being sewn to the first strap at a first attachment point and the web can be coupled to the second strap by being sewn to the second strap at a second attachment point.

In various examples, the harness has a front and a back. The connector and the web can be positioned on the back of the harness.

In various aspects, a harness configured to be worn on a body of a user for fall protection is provided. The harness includes a connector, a first strap coupled to the connector, a second strap coupled to the connector, and a web that is coupled to the first strap and the second strap. The web can be configured to be positioned at least partially between the body of the user and the connector.

In various examples, the web is X-shaped.

In various examples, the first strap includes an upper portion and a lower portion and the second strap includes an upper portion and a lower portion. The web can be coupled to the upper portions and the lower portions of each of the first strap and the second strap

In various examples, the web includes a first portion and a second portion. The first portion of the web can be coupled to the first strap. The second portion of the web can be coupled to the second strap.

In various examples, the connector includes a safety device interface configured to engage a first safety device so as to operatively couple the first safety device to the connector.

In various examples, the first strap is coupled to the connector by extending through a first upper base opening of the connector, extending behind the connector, and extending through a first lower base opening of the connector. The second strap can be coupled to the connector by extending through a second upper base opening of the connector, extending behind the connector, and extending through a second lower base opening of the connector.

In various examples, the web can be coupled to the first strap by being sewn to the first strap at the first attachment point and the web can be coupled to the second strap by being sewn to the second strap at the second attachment point.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure are described with reference to the following figures, which are not necessarily drawn to scale and wherein like reference numerals refer to like parts throughout the various views unless otherwise specified. The components illustrated in the figures may or may not be present in certain embodiments described herein. Some embodiments may include fewer (or more) components than those shown in the figures.

FIGS. 1-3 provide perspective views of a harness, as worn during operation by a user, in accordance with an example embodiment.

FIG. 4 provides a perspective view of a portion of the back of the harness of FIGS. 1-3, in accordance with an example embodiment.

FIG. 5 provides a front view of a connector of the harness of FIGS. 1-3, in accordance with an example embodiment.

FIG. 6 provides a front view of a portion of the back of the harness of FIGS. 1-3, in accordance with an example embodiment.

FIG. 7 provides a back view of the portion of the back of the harness of FIGS. 1-3, in accordance with an example embodiment.

### DETAILED DESCRIPTION

One or more embodiments are now more fully described with reference to the accompanying drawings, wherein like reference numerals are used to refer to like elements throughout and in which some, but not all embodiments of the inventions are shown. In the following description, for purposes of explanation, numerous specific details are set forth in order to provide a thorough understanding of the various embodiments. It is evident, however, that the various embodiments can be practiced without these specific details. It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements.

As used herein, the term “exemplary” means serving as an example, instance, or illustration. Any aspect or design described herein as “exemplary” is not necessarily to be construed as preferred or advantageous over other aspects or designs. Rather, use of the word exemplary is intended to present concepts in a concrete fashion. In addition, while a particular feature may be disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the term “positioned directly on” refers to a first component being positioned on a second component such that they make contact. Similarly, as used herein, the term “positioned directly between” refers to a first component being positioned between a second component and a third component such that the first component makes contact with both the second component and the third component. In contrast, a first component that is “positioned between” a second component and a third component may or may not have contact with the second component and the third component. Additionally, a first component that is “positioned between” a second component and a third component is positioned such that there may be other intervening components between the second component and the third component other than the first component.

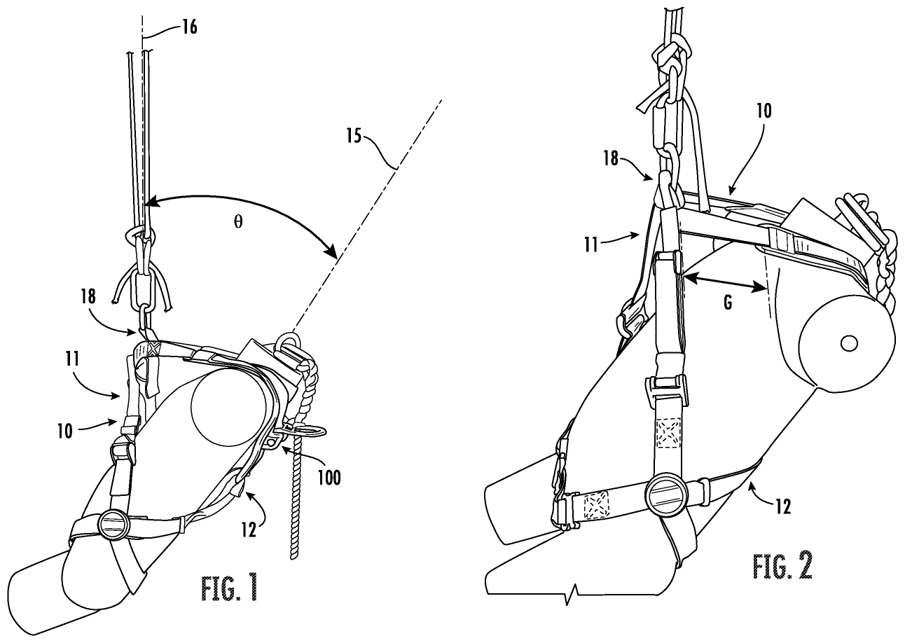

Referring now to FIGS. 1-3, perspective views of a harness 10, as worn during operation by a user, are provided, in accordance with an example embodiment. The harness 10 can have a front 11 and a back 12. In various examples, the harness 10 includes a first strap 201 and a second strap 202 (FIG. 3). The first strap 201 can include an upper portion 201a and a lower portion 201b. The second strap 202 can include an upper portion 202a and a lower portion 202b. The upper portion 201a of the first strap 201 and the upper portion 202a of the second strap 202 can be configured to be worn on the upper body of a user during operation. For example, the upper portion 201a of the first strap 201 and the upper portion 202a of the second strap 202 can be configured to extend from the back of the user, over the user's shoulder's and to the chest of the user during operation. As depicted in FIG. 3, the lower portion 201b of the first strap 201 and the lower portion 202b of the second strap 202 can be configured to extend from the back 12 of the harness 10 and can extend towards the hips of the user during operation.

As will be discussed further, the harness 10 can include a connector 100 (FIG. 5). The first strap 201 and the second strap 202 can each extend through and/or be coupled to the connector 100. The connector 100 can be configured as a back plate of the harness 10. The connector 100 can be manufactured from, or include a plastic. For example, the connector 100 can be manufactured from or include polyurethane and/or ethylene-vinyl acetate.

In various examples, the material of the first strap 201 and/or the second strap 202 may be based on a given application of the harness 10. In various embodiments, the first strap 201 and/or the second strap 202 may include polyester, nylon, and/or the like. In various embodiments, the size and shape of the first strap 201 and/or the second strap 202 may be based on the weight to be carried during operation. In various embodiments, the size (e.g., thickness, width) of the first strap 201 and/or the second strap 202, strap material, and/or attachment methods (e.g., sewing pattern and/or thread thickness may be increased) may be chosen based on the weight to be carried during operation (e.g., a 125 kg harness may have straps 201, 202 with a larger thickness than the straps 201, 202 of a 100 kg harness).

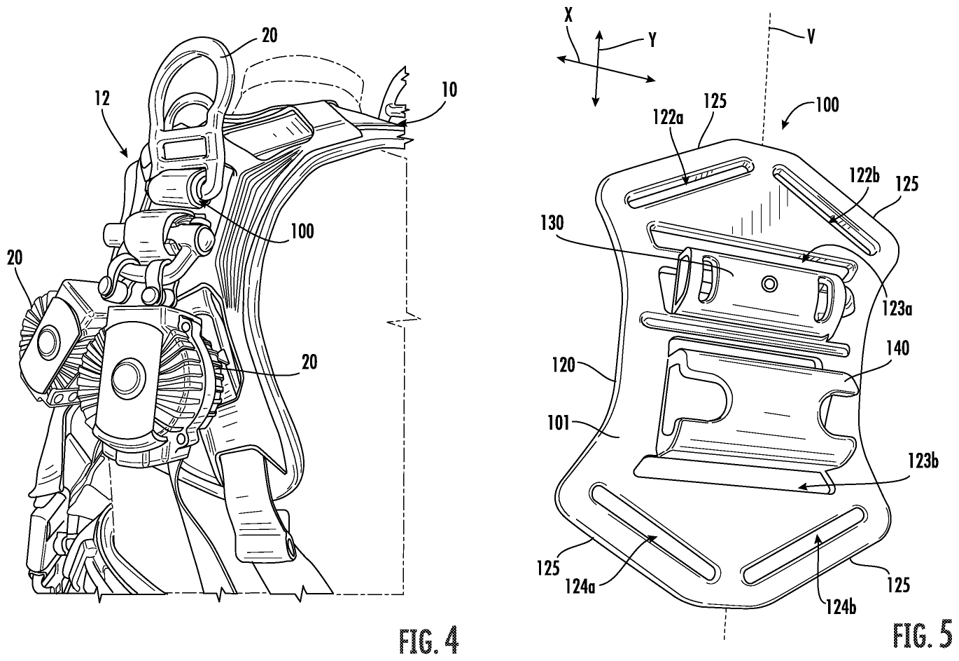

Referring now to FIG. 4, a perspective view of a portion of the back 12 of the harness 10 of FIGS. 1-3 is provided, in accordance with an example embodiment. As discussed, the harness 10 can include a connector 100. The connector 100 can be positioned on the back 12 of the harness 10. The connector 100 can include a first safety device interface 130 that is configured to be coupled, directly or indirectly, to a safety device 20. The connector 100 can include a second safety device interface 140 that is configured to be coupled, directly or indirectly, to a safety device 20. The safety device(s) can be a personal fall limiter, a self-retracting lifeline, a rope, a lanyard, a cable, or the like.

Referring now to FIG. 5, a view of the connector 100 of the harness 10 of FIGS. 1-3 is provided, in accordance with an example embodiment. The connector 100 of the harness 10 can define an X direction and a Y direction that is orthogonal to the X direction. The Y direction can be a vertical direction and the X direction can be a horizontal direction. The connector 100 can have a front side 101 and a back side 102 (FIG. 7) that is opposite to the front side 101. The connector 100 can have a base 120. The first safety device interface 130 and/or the second safety device interface 140 can extend away from the base 120 and be positioned on the front side 101 of the connector 100.

In various examples, the connector 100 has a first upper base opening 122a, a second upper base opening 122b, a first lower base opening 124a, and a second lower base opening 124b. The connector 100 can be substantially symmetrical (e.g., symmetrical within manufacturing tolerances) along a vertical line V defined by the connector 100 that extends in the Y direction. Each of the base openings 122a, 122b, 124a, and 124b can be configured as elongate slots that extend relative to the vertical line V by approximately 60 degrees, such as at least 40 degrees and up to 80 degrees, such as at least 50 degrees and up to 70 degrees, such as at least 55 degrees and up to 65 degrees. Each of the base openings 122a, 122b, 124a, and 124b can be positioned proximate to a corresponding edge 125 of the base 120 of the connector 100. Each of the base openings 122a, 122b, 124a, and 124b can extend generally parallel to the corresponding edge 125 of the base 120 of the connector 100.

In various examples, the connector 100 includes base opening 123a and base opening 123b that can extend generally in the X direction. Base opening 123a and base opening 123b can be positioned between the upper base openings 122a, 122b and the lower base opening 124a, 124b.

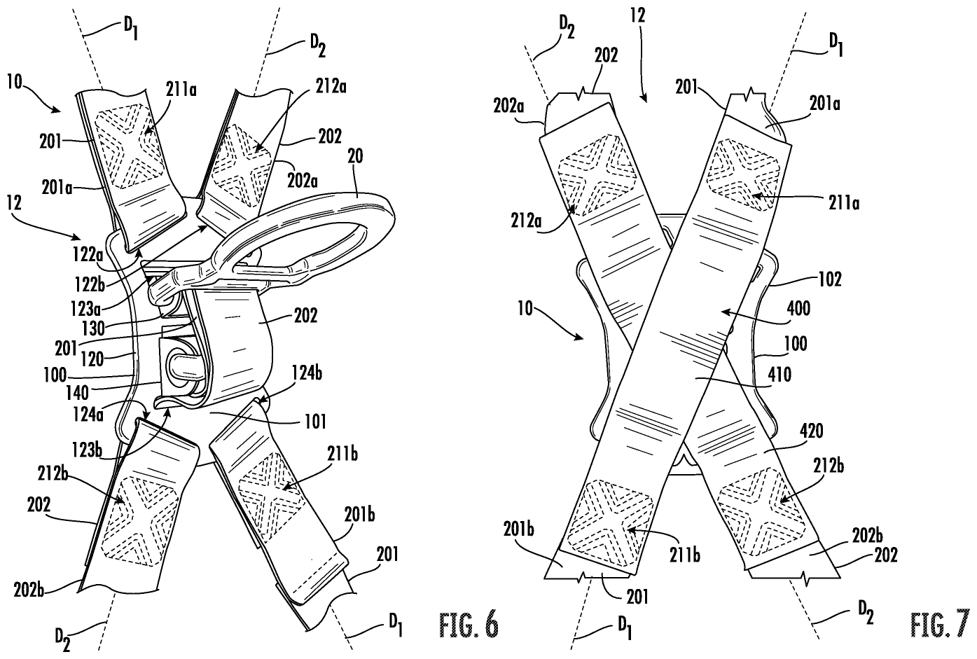

Referring now to FIGS. 6 and 7, views of a portion of the back 12 of the harness 10 of FIGS. 1-3 are provided, in accordance with an example embodiment. More specifically, FIG. 6 provides a front view of a portion of the back 12 of the harness 10 and FIG. 7 provides a back view of the portion of the back 12 of the harness 10. In various examples, the upper portion 201a of the first strap 201 and the lower portion 201b of the first strap 201 are a unitary component and the upper portion 202a of the second strap 202 and the lower portion 202b of the second strap 202 are a unitary component. Stated differently, the upper portions 201a, 202a are not separate components from the lower portions 201b, 202b.

In various examples, the first upper base opening 122a of the connector 100 is configured to receive the upper portion 201a of the first strap 201. The second upper base opening 122b can be configured to receive the upper portion 202a of the second strap 202. The first lower base opening 124a can be configured to receive the lower portion 202b of the second strap 202. The second lower base opening 124b can be configured to receive the lower portion 201b of first strap 201.

In various examples, each strap 201, 202 can be configured to extend towards and into the corresponding upper base opening 122a, 122b on the front side 101 of the connector 100, then behind the connector 100 and into the base opening 123a on the backside 102 (FIG. 7) of the connector, then into the base opening 123b on the front side 101 of the connector, then behind the connector 10 and into the corresponding lower base opening 124a, 124b on the back side 102 of the connector, and then extend away from the connector 100.

In various examples, the upper portions 201a, 202a of each strap 201, 202 are not unitary with the lower portions 201b, 202b of each strap 201, 202. Instead, the upper portions 201a, 202a are separate components from the lower portions 201b, 202b. When they are separate components, each portion 201a, 202a, 201b, 202b can be configured to extend towards and into the corresponding base opening 122a, 122b, 124a, and 124b on the front side 101 of the connector 100, then extend out of the corresponding base opening 122a, 122b, 124a, and 124b on the back side 102 (FIG. 7) of the connector 100, and then extend away from the corresponding base opening 122a, 122b, 124a, and 124b and away from the connector 100. Stated differently, each portion 201a, 202a, 201b, 202b can form a loop, such as a closed loop, that extends through a corresponding base opening 122a, 122b, 124a, and 124b. For example, each portion 201a, 202a, 201b, 202b can be doubled back on itself and can form a bight.

The portion that extends towards the corresponding base opening 122a, 122b, 124a, and 124b on the front side 101 of the connector 100 can be coupled to the portion that extends away from the corresponding base opening 122a, 122b, 124a, and 124b on the back side 102 of the connector 100 at least at a corresponding attachment point 211a, 212a, 211b, and 212b. For example, the portion of each strap 201, 202 that extends towards the corresponding base opening 122a, 122b, 124a, and 124b on the front side 101 of the connector 100 can be sewn (e.g., sewn with thread) to the portion that extends away from the corresponding base opening 122a, 122b, 124a, and 124b on the back side 102 of the connector 100 at least at the corresponding attachment point 211a, 212a, 211b, and 212b.

As used herein, the term “attachment point” may refer to a general location of attachment. For example the sewing patterns (e.g., the thread that makes up the sewing pattern) depicted in FIGS. 6 and 7 can define the general location of the attachment point. As discussed, the sewing pattern and/or the thread thickness may be increased, or decreased according to the expected weight to be carried by the harness 10 during operation. Additionally, even though the present disclosure often refers to sewing as a fastening means at the attachment points, it should be understood that other fastening means are contemplated. For example, the fastening means can include adhesive, rivets, clamps, and/or melting, at least partially, the straps and/or the web to meld the straps and/or the web together.

In various examples, the straps 201, 202 are separate components that are not directly coupled to each other. For example, the straps 201, 202 are only indirectly coupled to each other through the connector 100. The straps 201, 202 and/or the straps 201, 202 and the connector 100 can, collectively, be X-shaped. For example, the first strap 201 can extend generally along a first diagonal direction D1. The second strap 202 can extend generally along a second diagonal direction D2. The first diagonal direction D1 and the second diagonal direction D2 may intersect with each other, which may form an X-shape. For example, the first diagonal direction D1 and the second diagonal direction D2 may intersect approximately at a horizontal center and/or a vertical center of the connector 100. In various example, an angle between the first diagonal direction D1 and the second diagonal direction D2 is approximately 45 degrees, such as at least 35 degrees and up to 55 degrees, such as at least 40 degrees and up to 50 degrees.

In various examples, and as depicted in FIG. 7, the harness 10 includes a web 400. The web 400 can be coupled to each of the straps 201, 202. For example, the web 400 can be coupled to each of the straps 201, 202 at a corresponding attachment point 211a, 211b, 212a, 212b. In various examples, the web 400 is sewn to each of the straps 201, 202.

The attachment points 211a, 211b, 212a, 212b can be positioned proximate to the connector 100. For example, the attachment points 211a, 211b, 212a, 212b can be sewn generally as close as practically possible with the use of a sewing machine. In various examples, the web 400 is a separate component than the straps 201, 202.

The web 400 can include a first portion 410. The first portion 410 can be coupled to the upper portion 201a of the first strap 201 and to the lower portion 201b of the first strap 201. The web 400 can include a second portion 420. The second portion 420 can be coupled to the upper portion 202a of the second strap 202 and the lower portion 202b of the second strap 202. The first portion 410 of the web 400 may extend from the upper portion 201a of the first strap 201, behind the connector 100, and to the lower portion 201b of the first strap 201. The second portion 420 can extend from the upper portion 202a of the second strap 202, behind the connector 100, and to the lower portion 202b of the second strap 202. In various examples, and as depicted, neither the first portion 410 nor the second portion 420 of the web 400 are directly coupled to the connector 100.

In various examples, and as depicted in FIG. 7, the first portion 410 and the second portion 420 of the web 400 are separate components. For example, the second portion 420 may cross over the first portion 410, or vice versa. In various examples, the first portion 410 and the second portion 420 of the web 400 are unitary components.

The web 400 may be X-shaped. For example, the first portion 410 and the second portion 420 may collectively form an X-shape. In various examples, the first portion 410 extends generally along the first diagonal direction D1 and the second portion 420 extends generally along the second diagonal direction D2, which may form the X-shape.

In various embodiments, the web 400 (e.g., the first portion 410 and the second portion 420 of the web 400) may include polyester, nylon, and/or the like. In various embodiments, the size and shape of the web 400 (e.g., the first portion 410 and the second portion 420 of the web 400) may be based on the weight to be carried during operation. In various embodiments, the size (e.g., thickness and/or width) of the web 400 (e.g., the first portion 410 and the second portion 420 of the web 400), web material, and/or attachment methods (e.g., sewing pattern and/or thread size may be increased) may be chosen based on the weight to be carried during operation.

In various examples, at least a portion of the web 400 is positioned behind the connector 100 (e.g., proximate to the back side 102 of the connector 100). For example, at least a portion of the web 400 (e.g., a portion of the first portion 410 and a portion of the second portion 420 of the web 400) can be configured to be positioned between the connector 100 and the body of the user wearing the harness 10.

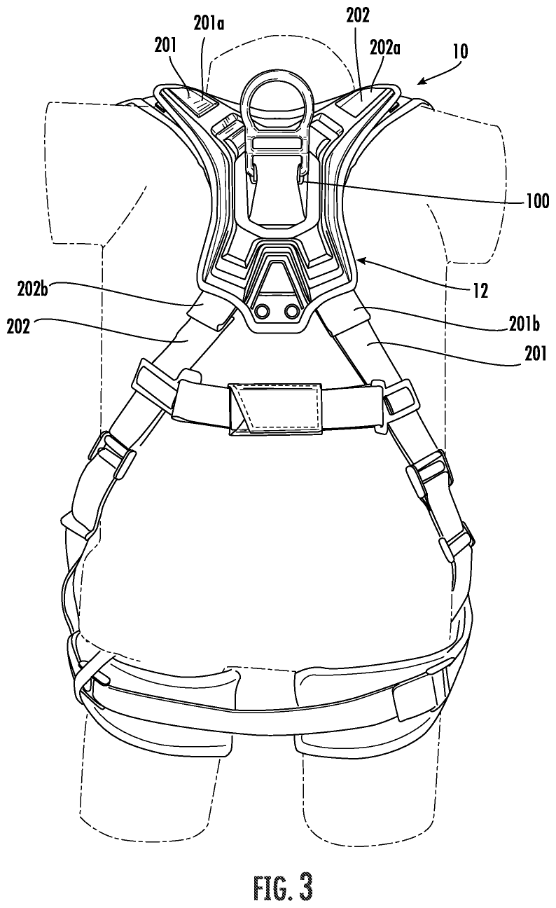

The harness 10 (FIG. 1-3) that includes the web 400 has various benefits. For example, and referring back to FIGS. 1 and 2, the harness 10 with the web 400 may reduce a gap G (FIG. 2) that is formed between the body of the user and the front 11 of the harness 10 after a fall event (e.g., directly after a fall event) as compared to some prior art harnesses. In various examples, the gap G is formed between the body of the user and the back 12 of the harness 10 after a fall event. Reducing the gap G may also reduce an angle Θ (FIG. 1) that is defined between a first line 15 that extends longitudinally through a user's body after a fall event and a second line 16 that extends vertically from an attachment mechanism 18 on the front 11 (or the back 12) of the harness 10 after a fall event. For example, in certain circumstances, the angle Θ after a fall event with the user wearing the harness 10 as presently described may be 50 degrees or less, which may reduce the likelihood of injury to the user and/or may minimize the anxiety of the user after a fall event.

Some prior art harnesses may experience deformation of the back plate during a fall event, which may cause the gap G to exceed a preferred distance between the body of the user and the front 11 of the harness 10 during a fall event. The deformation of the back plate may be caused by a force being transmitted substantially through the back plate, the force being caused by the fall event. However, providing the web 400 to the harness 10 may allow at least some of the force caused by the fall event to be transmitted through the web 400 instead of through the back plate, such as connector 100. This may prevent deformation of the connector 100, which may achieve the preferred angle Θ that is 50 degrees or less.

Some prior art harnesses may result in an angle Θ that does not exceed 50 degrees. However, these prior art harnesses may not include safety device interfaces, such as first safety device interface 130 or second safety device interface 140. As such, the harness 10 of the present disclosure allows safety devices 20 (FIG. 4) to be coupled to the connector 100 and may also achieve the preferred angle Θ that is 50 degrees or less after a fall event, which may be beneficial.

Additionally, the harness 10 that includes the web 400 may prevent the connector 100 from sliding along the straps 201, 202. For example, during a head-down fall event, the web 400 may prevent the connector 100 from sliding towards the user's hips and during a head-up fall event, the web 400 may prevent the connector 100 from sliding up towards the user's neck. In various examples, the fastening means at the attachment points 211a, 211b, 212a, 212b may prevent the connector 100 from sliding along the straps 201, 202. Preventing the connector 100 from sliding along the straps 201, 202 may increase the comfort and minimize the anxiety of the user after a fall event. Also, preventing the connector 100 from sliding along the straps 201, 202 may minimize the gap G and the angle Θ, which is beneficial.

### CONCLUSION

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the appended claims below. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A harness comprising:
a connector;
a first strap coupled to the connector;
a second strap coupled to the connector; and
a web that is coupled to the first strap and the second strap, wherein the web is positioned at least partially behind the connector.

2. The harness of claim 1, wherein the web is X-shaped.

3. The harness of claim 1, wherein the first strap comprises an upper portion and a lower portion and the second strap comprises an upper portion and a lower portion, wherein the web is coupled to the upper portions and the lower portions of each of the first strap and the second strap.

4. The harness of claim 1, wherein the web comprises a first portion and a second portion, wherein the first portion of the web is coupled to the first strap, and wherein the second portion of the web is coupled to the second strap.

5. The harness of claim 4, wherein the first portion is positioned at an angle relative to the second portion, wherein the angle is at least 35 degrees and up 55 degrees.

6. The harness of claim 4, wherein the first portion or the second portion crosses over the other of the first portion or the second portion.

7. The harness of claim 1, wherein the connector comprises a safety device interface configured to engage a first safety device so as to operatively couple the first safety device to the connector.

8. The harness of claim 1, wherein the connector comprises a base that comprises a first base opening configured to receive the first strap and a second base opening configured to receive the second strap.

9. The harness of claim 1, wherein the web is not directly coupled to the connector.

10. The harness of claim 1, wherein the web is sewn to the first strap and the second strap.

11. The harness of claim 1, wherein the first strap is coupled to the connector by extending through a first upper base opening of the connector, extending behind the connector, and extending through a first lower base opening of the connector, and wherein the second strap is coupled to the connector by extending through a second upper base opening of the connector, extending behind the connector, and extending through a second lower base opening of the connector.

12. The harness of claim 1, wherein the web is coupled to the first strap by being sewn to the first strap at a first attachment point and the web is coupled to the second strap by being sewn to the second strap at a second attachment point.

13. The harness of claim 1, wherein the harness has a front and a back, wherein the connector and the web are positioned on the back of the harness.

14. A harness configured to be worn on a body of a user for fall protection, the harness comprising:
a connector;
a first strap coupled to the connector;
a second strap coupled to the connector; and
a web that is coupled to the first strap and the second strap, wherein the web is configured to be positioned at least partially between the body of the user and the connector.

15. The harness of claim 14, wherein the web is X-shaped.

16. The harness of claim 14, wherein the first strap comprises an upper portion and a lower portion and the second strap comprises an upper portion and a lower portion, wherein the web is coupled to the upper portions and the lower portions of each of the first strap and the second strap.

17. The harness of claim 14, wherein the web comprises a first portion and a second portion, wherein the first portion of the web is coupled to the first strap, and wherein the second portion of the web is coupled to the second strap.

18. The harness of claim 14, wherein the connector comprises a safety device interface configured to engage a first safety device so as to operatively couple the first safety device to the connector.

19. The harness of claim 14, wherein the first strap is coupled to the connector by extending through a first upper base opening of the connector, extending behind the connector, and extending through a first lower base opening of the connector, and wherein the second strap is coupled to the connector by extending through a second upper base opening of the connector, extending behind the connector, and extending through a second lower base opening of the connector.

20. The harness of claim 14, wherein the web is coupled to the first strap by being sewn to the first strap at a first attachment point and the web is coupled to the second strap by being sewn to the second strap at a second attachment point.
